(19) United States
(12) Patent Application Publication
(10) Pub. No.: US 2018/0025321 A1
(43) Pub. Date: Jan. 25, 2018

(54) SYSTEM AND METHOD OF DELIVERY TO A MOBILE PURCHASER

(71) Applicants: Eric CHEN, Shanghai (CN); GM GLOBAL TECHNOLOGY OPERATIONS LLC, Detroit, MI (US)

(72) Inventors: Eric Chen, Shanghai (CN); Peggy Wang, Shanghai (CN); Xiaowen Dai, Shelby township, MI (US); Jiang Du, Beaverton, OR (US)

(73) Assignee: GM GLOBAL TECHNOLOGY OPERATIONS LLC, Detroit, MI (US)

(21) Appl. No.: 15/549,849

(22) PCT Filed: Feb. 9, 2015
(86) PCT No.: PCT/CN2015/072527

§ 371 Date: Aug. 9, 2017

(51) Int. Cl. G06Q 10/08

(52) U.S. Cl. CPC G06Q 10/08355; H04W 4/02

(57) ABSTRACT

A system and method are disclosed for dispatching and delivering a purchased item to a dynamic delivery address for an mobile purchaser. Once a delivery mode and a dynamic delivery address for delivery of a purchased item from an mobile purchaser interface is acquired, a time for delivery is estimated based on the delivery mode, the dynamic delivery address and an initial location of the mobile purchaser interface. A dispatch schedule is determined based on the delivery mode, the initial location and the estimated time for delivery. A delivery schedule including a delivery route is determined based on the dynamic delivery address, the updated location and the estimated time for delivery and the delivery schedule is issued to a delivery interface.

### TECHNICAL FIELD

The technical field generally relates to systems and methods for delivering goods and/or services to a purchaser, and more particularly to systems and methods for dispatching and delivering goods/services to a mobile purchaser.

### BACKGROUND

Consumers today are becoming more accustomed to making purchases and payments using electronic commerce (“e-commerce”). Even mobile e-commerce on hand held computing devices such as smart phones and tablets has become familiar to consumers. Most of these transactions relate to on-line purchases of consumer goods, but are not linked to the purchaser's locale. In this regard, conventional e-commerce applications are not optimized for mobile purchases because they require a delivery location such as the purchaser residence or business address that is geographically fixed or a pick-up location such as a vendor's store. While some merchants provide walk-up or drive-through accommodations for pick up, in most cases the purchaser must go the vendor's place of business to accept delivery of the goods/services.

Accordingly, it is desirable to provide a multi-purposed method and system for dispatching and delivering goods/services to a mobile purchaser. By adapting the delivery process to accommodate a mobile purchase, the method and system is capable of creating an instant delivery experience for on-the-go transactions. In addition, other desirable features and characteristics of the present disclosure will become apparent from the subsequent detailed description and the appended claims, taken in conjunction with the accompanying drawings and the foregoing technical field and background.

### SUMMARY

A method and system in accordance with the present disclosure implements a dynamic delivery address to dispatch and deliver goods/services to a mobile purchaser in a timely, efficient and optimized manner. The method and system may account for the nature and classification of the goods/service which may include acquisition, preparation, and/or assembly of the goods/service. For example, a fresh food product may need to be prepared and cooked in advance of dispatching it for delivery. In contrast, an inventoried product such as a prepackage beverage or a consumer goods does not require time in advance of dispatching the product for delivery. The method and system also accounts for a preferred delivery configuration which may include customer preference, current location, specific destination, daily routes, activity history, estimated time of departure, or estimated time of arrival to name a few. The method and system may also monitor deviation from the delivery route, and respond to such deviations by changing the delivery route to accommodate the dynamic delivery address deviation, changing the dispatch schedule or transferring the dispatch schedule to another vendor. The method and system may also track the location and/or estimated arrival time to the dynamic delivery address and issue notifications to the mobile purchaser and/or a deliver person and update a delivery status such on-the-way, time changed, address changed, newly-dispatched, canceled or completed.

In one embodiment, a method for dispatching and delivering a purchased item to a dynamic delivery address for a mobile purchaser is disclosed which includes acquiring a delivery mode and a dynamic delivery address for delivery of a purchased item from a mobile purchaser interface. A time for delivery is estimated based on the delivery mode, the dynamic delivery address and an initial location of the mobile purchaser interface. A dispatch schedule is determined based on the delivery mode, the initial location and the estimated time for delivery. The dispatch schedule may be issued to the mobile purchaser interface and/or a delivery interface. An updated location is acquired from a telematics device such as a GPS system associated with the mobile purchaser module. A delivery schedule including a delivery route is determined based on the dynamic delivery address, the updated location and the estimated time for delivery. The delivery schedule is issued to the delivery interface. Once the purchased item is delivered to the dynamic delivery address, a confirmation for delivery may be acquired.

In one embodiment, a dispatch and delivery system is disclosed which facilitates delivery of a purchased item to a dynamic delivery address associated with a mobile purchaser. The system includes a mobile purchaser module, such as a purchaser module deployed in a vehicle, and having a telematics device for locating the purchaser module, and a purchaser interface configured to issue delivery data to and acquire delivery data from the dispatch and delivery system. The purchaser module may include a data store for storing and retrieving delivery data and position data. The system also includes a dispatch module having a dispatch interface configured to issue delivery data to and acquire delivery data from the dispatch and delivery system. The dispatch module is operable to estimate a time for delivery based on a delivery mode, a dynamic delivery address and location data for the purchaser interface, to determine a dispatch schedule based on the delivery mode, an initial location of the purchaser interface and the estimated time for delivery. The system further includes a delivery module deployed remote from the purchaser module and having a telematics device for locating the delivery module and a delivery interface for issuing delivery data to and acquiring delivery data from the dispatch and delivery system. The delivery module may include a data store accessible by the delivery interface and the second telematics system for storing and retrieving delivery data and location data. The purchaser module, the dispatch module and the delivery module are in data communication across a data network and cooperate to execute the method for dispatching and delivering a purchased item to a dynamic delivery address for a mobile purchaser as further described herein.

The method and system in accordance with the present disclosure provides an intelligent and flexible process flow to dispatch and deliver goods/services to a mobile purchaser (such as the occupant(s) of an in-transit vehicle).

### DESCRIPTION OF THE DRAWINGS

The exemplary embodiments will hereinafter be described in conjunction with the following drawing figures, wherein like numerals denote like elements, and wherein:

FIG. 1 is a functional block diagram of a dispatch and delivery system for facilitating delivery of a purchased item to a dynamic delivery address associated with a mobile purchaser;

FIG. 2 is a diagram illustrating the general work flow for dispatch and delivery system illustrated in FIG. 1;

FIG. 3A is a diagram detailing the process flow for scheduling a delivery and coordinating the dispatch of the purchased item; and

FIG. 3B is a continuation of the diagram shown in FIG. 3A detailing the process flow for coordinating scheduling and confirming a delivery.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, computer, electronic control component, processing logic, and/or processor device, individually or in any combination, including without limitation: application specific integrated circuit (ASIC), an electronic circuit, a processor (shared, dedicated, or group) with suitable memory and peripheral devices that executes one or more computer programs or code embodied in software or firmware on a transitory or non-transitory medium, a combinational logic circuit, and/or other suitable components to provide the described functionality.

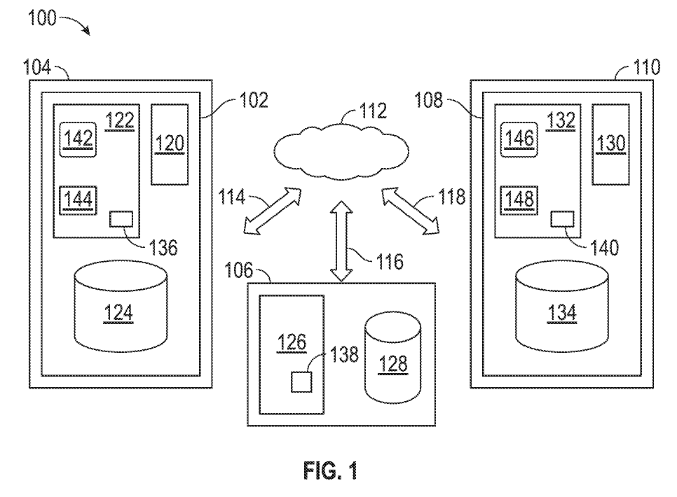

FIG. 1 is a functional block diagram showing a dispatch and delivery system 100 for facilitating delivery of a purchased item to a dynamic delivery address associated with an mobile purchaser. In this regard, the dynamic delivery address is a specified location for delivery of a purchased item which may change over time or as a function of mobile purchaser and/or may be specified based on a delivery mode. A dynamic delivery address is to be contrasted with static delivery address which is the same over time and does not change based on a delivery mode.

The dispatch and delivery system 100 includes a mobile purchaser module 102, a dispatch module 106 and a delivery module 108. Although the figures shown herein depict an example with certain arrangements of elements, additional intervening elements, devices, features, or components may be present in actual embodiments. For example, the mobile purchase and payment system 100 will be further described with reference to a vehicular application in which the dispatch and delivery system is described in the context of a mobile transaction from a vehicle. However, one skilled in the art will understand that the present disclosure is not be limited to in-vehicle transactions, but may more broadly encompass mobile transactions, in general As used herein, the term vehicle, unless otherwise expressly limited, refers broadly to any device or apparatus for transporting a person or persons whether motorized or not. For example, a vehicle may be a land vehicle (such as a bicycle, automobile, RV, trailer, truck, tractor-trailer, bus, train, etc.) or a marine craft or an aircraft and should not be limited to a passenger vehicle.

The mobile purchaser module 102 may be deployed in a vehicle 104 in transit. The dispatch module 106 may be deployed with a remote online marketplace system. The delivery module 108 may be deployed with a vendor and may also be mobile in that that the delivery module 108 is deployed in a delivery vehicle 110. Each of these modules 104, 106, 108 is in data communications with the other modules through a data network 112 and communication links 114, 116, 118. These may be direct communication links or may interconnect though a shared network or through an intermediary which may have shared resources, software, applications and/or information. Communications may be enable through a cellular communications services such as the OnStar® in-vehicle device, a wireless communication device which employs high-speed data communication such as 3G, LTE, 4G, LTE Advanced or other mobile communication technologies.

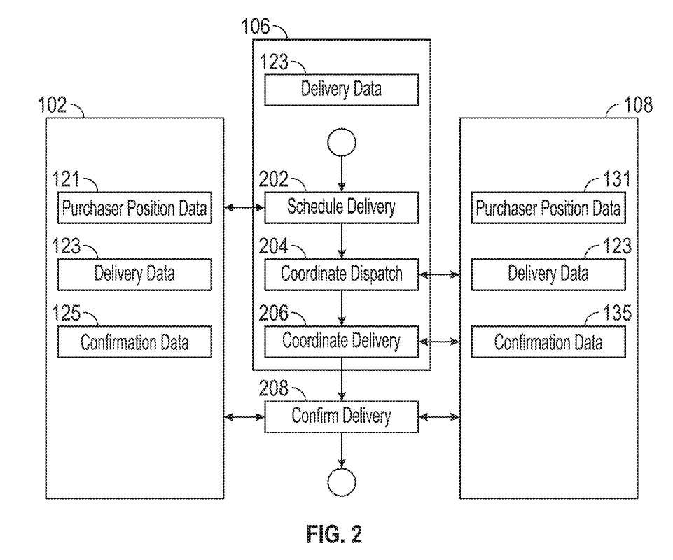

The dispatch module 106 is schematically illustrated as a separate component in FIG. 1 however one skilled in the art will recognize that the structure and function of the dispatch module 106 may be distributed across the dispatch and delivery system 100. As currently contemplated and with further reference to FIGS. 1 and 2, the general work flow 200 of the dispatch and delivery system 100 is as follows. The purchaser module 102 primarily functions to schedule deliveries 202 of a purchased item and confirm deliveries 208 of the purchased item from a delivery person. The dispatch module 106 primarily functions to coordinate dispatch 204 of the purchased item and coordinate delivery 206, namely purchased item pick-up from a vendor. The delivery module 108 primarily functions to coordinate delivery 206 and confirm delivery 208 of the purchased item to the purchaser. In this configuration, the dispatch and delivery system 100 is able to track a location of at least one of the purchaser module 102 and the delivery module 108 relative to the dynamic delivery address, compute an estimated arrival time at the dynamic delivery address, and issue a notification to at least one of the mobile purchaser interface 122 and the delivery interface 132 to update a delivery status. The delivery status may be one of on-the-way, time changed, address changed, newly-dispatched, canceled or completed.

The purchaser module 102 includes a telematics system 120 configured to acquire purchaser position data 121 for locating the purchaser module 102. In one example, the telematics system 120 is a GPS tracking device but may also include other devices that acquire and transmit location and time information associated with a moving vehicle. The purchaser module 102 also includes an mobile purchaser interface 122 configured to issue and acquire delivery data 123 locally within the purchaser module 102 and across the data network 112 via communication link 114. The purchaser interface 122 may be configured to issue confirmation data 125 for confirming receipt of the purchased item at the dynamic delivery address with the delivery module 108. The delivery data 123 may include a purchase order, a delivery mode, a dynamic delivery address, as well as purchaser position data 121 for the purchaser module 102. The delivery mode can be selected from delivery at an in-route pick-up point, a daily route or based on an activity history logged in the data store 124. The purchaser module 102 further includes a data store 124 accessible by the purchaser interface 122 and the telematics system 120 for storing and retrieving delivery data and position data.

The dispatch module 108 includes a dispatch interface 126 configured to issue and acquire delivery data 123 locally within the dispatch module 108 and across the data network 112 via communication link 116. The dispatch interface 126 acquires delivery data 121 from the mobile purchaser module 102 including a purchase order for a purchased item, as well as delivery mode, the dynamic delivery address and location data, then estimates a time for delivery for the purchased item. The dispatch module 106 determines a dispatch schedule based on the delivery mode, the initial location and the estimated time for delivery. Thus, the delivery data may further include a time of delivery and a dispatch schedule. The dispatch module 108 further includes a data store 128 accessible by the dispatch interface 126 for storing and retrieving delivery data 123 and position data 121, 131.

The delivery module 110 includes a telematics device 130 configured to acquire delivery position data 131 for locating the delivery module 108. In one example, the telematics system 130 is a GPS tracking device but may also include other devices that acquire and transmit location and time information associated with a moving object. The delivery module 108 also includes a delivery interface 132 configured to issue and acquire delivery data 123 locally within the delivery module 108 and across the data network 112 via communication link 118. Thus, the delivery data 123 may further include a time for delivery, a delivery schedule, and a delivery route. The delivery interface 132 may acquire an updated location based on position data 121 from the mobile purchaser interface 122 across the data network (1142, 114, 118), then estimate an updated time for delivery. The delivery interface 132 determines a delivery schedule including a delivery route based on the dynamic delivery address, the updated location and the estimated time for delivery, and issues a delivery schedule. Thus, the delivery data may further include a delivery schedule, a delivery route and updated location and time for delivery. The delivery module 110 further includes a data store 134 accessible by the delivery interface 132 and the telematics device 130 for storing and retrieving delivery data 123 and delivery position data 131.

In one example, the purchaser module 102, dispatch module 106 and/or the delivery module 108 may include a near field communication or NFC device 134, 138, 140 to enable communication therebetween by means other than the data network 112 and communication links 114, 116, 118. Near field communication may be used for example to locate the purchaser at the delivery destination and to confirm delivery of the purchased item. For example, after the purchaser module 102 arrives at the dynamic delivery address, it may issue confirmation data 125 in the form of a request via the NFC device 136. Once the delivery module 108 receives the confirmation request, it may issue confirmation data 135 in the form of a response via the NFC device 140. Confirmation data 125, 135 may also be communicated to the purchaser module 102 and the delivery module 108, as well as the dispatch module 106 across the data network 112.

The purchaser module 102 includes a display device 142 configured to display position data 121, 131, delivery data 123 and confirmation data 125, 135 in human-discernable form such as text and/or graphics and an input device 144 configured to input delivery data 123 into the purchaser interface 122. Likewise, the delivery module 108 includes a display device 146 configured to display position data 121, 131, delivery data 123 and confirmation data 125, 135 in human-discernable form and an input device 148 configured to input delivery data 123 into the delivery interface 132. The dispatch and delivery system 100, and in one example, the purchaser module 102 and/or the delivery module 108, may be embodied in a hand held computing device such as a smart phone or tablet having a microprocessor and the interface includes an application program executed on the microprocessor to provide the structures and functions described above. The display and delivery system 100 may also be embodied as a computer program product including software for facilitating the dispatch and delivery of a purchased item to a dynamic delivery address for a mobile purchaser. The computer program product includes a non-transitory computer readable medium having instructions stored thereon, which when loaded into a computer memory and executed by a processor provide the structure and functions further detailed herein.

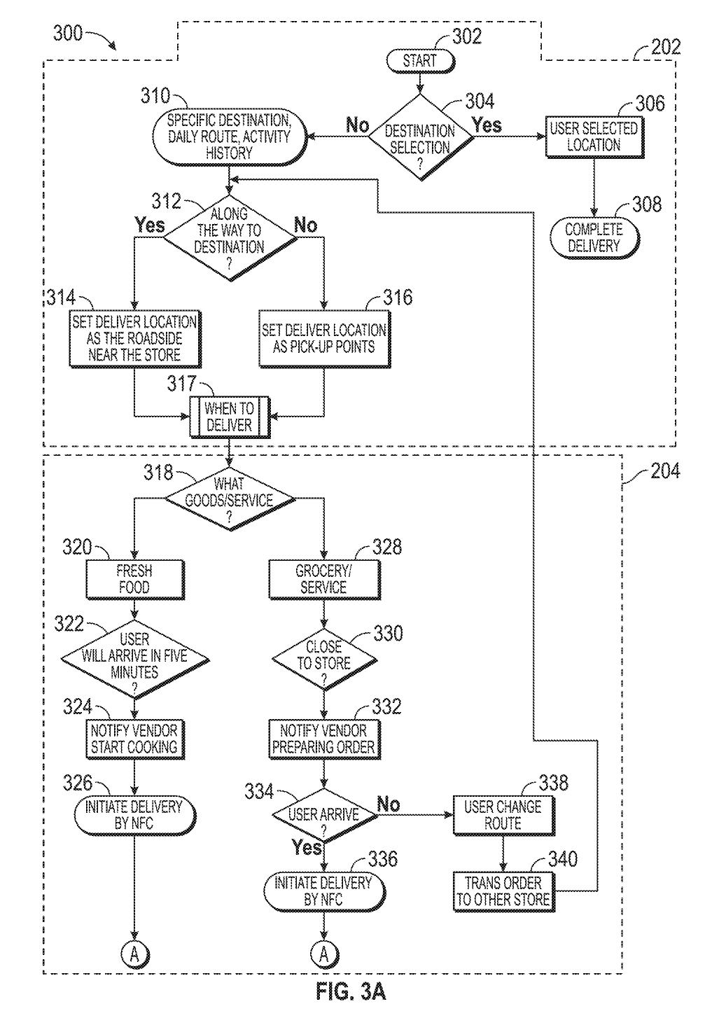

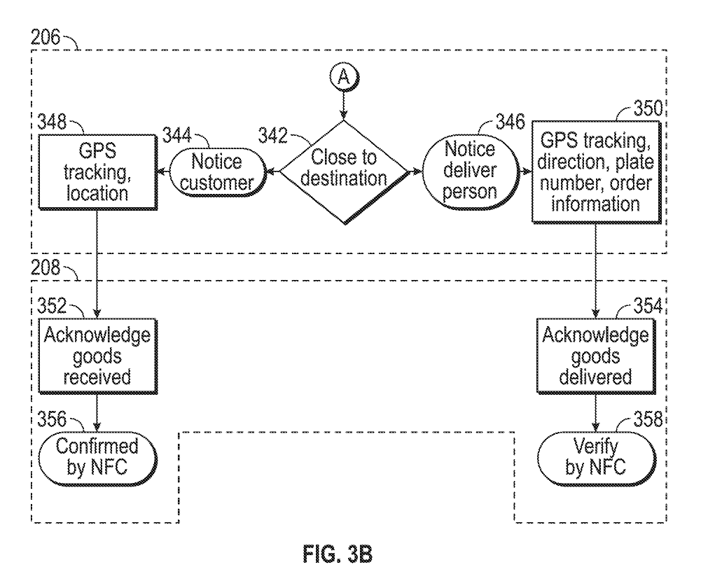

In one example, a method for dispatching and delivering a purchased item to a dynamic delivery address for an mobile purchaser using the dispatch and delivery system 100 will be further detailed with reference to FIGS. 2, 3A and 3B showing the general work flow 200 and the process details 300. The method is particularly well-suited to establish a delivery platform that integrates on-the-go customer needs and online marketplace system with flexible offline vendors and/or service providers to achieve a unique delivery experience. In this sense, the method accommodates a mobile purchaser such as an occupant(s) in a moving vehicle, as well as a preferred route to dispatch the purchase item based on a purchaser and/or delivery person's location, actual arrival time, specified pick-up location or other variables associated with the mobile transaction.

The purchaser, dispatch and delivery modules 102, 106, 108 may incorporate various supply chain modeling and project scheduling logic using the delivery data 123 and dependency relationships for the dispatch and delivery activities to determine the dispatch schedule and delivery schedule. To this end, the dispatch and delivery system 100 may implement a just-in-time production strategy relying on updated delivery data between the purchaser, dispatch and delivery modules 102, 106, 108, which are involved in the process, to dictate the dispatch and delivery sequences including the various deadlines (i.e. estimated time for dispatch, estimate time for delivery, estimate time for pick-up) necessary to meet the dispatch and delivery schedules.

Starting at block 302 in FIG. 3A, a delivery destination is entered or otherwise selected as shown at block 304 on the mobile purchaser interface 122. If delivery is to occur at a fixed or static delivery address as shown at block 306, then the method as described herein completes delivery at block 308 in a conventional delivery process. The fixed address may be a home address, an office address or some other geographically specific location such a public parking place. If delivery is to occur at a dynamic delivery address, then a delivery mode and a dynamic delivery address is acquired at block 310 for delivery of a purchased item from an mobile purchaser interface 122. The delivery mode may be set as a delivery location along a route at block 312 or based on an activity history as shown at block 314 or at a specified pick-up point as shown at block 316. A time for delivery is then estimated as shown at block 317 based on the delivery mode, the dynamic delivery address and an initial location of the mobile purchaser module 102. This concludes the schedule delivery function 202.

A dispatch schedule is determined based on the delivery mode, the initial location and the estimated time for delivery for dispatching the purchased item. The dispatch schedule may take into account the tasks necessary to dispatch the purchased item based on a classification of the purchased item as shown at block 318. For example, if the purchased item is classified as a made-to-order item such as fresh food as shown at block 320, then the dispatch schedule may adjust the dispatch time based on the estimated time of delivery as shown at block 322, notify the vendor to start preparing the purchased item as shown at block 324 and initiate delivery as shown as block 326.

Alternately, if at 318, the purchased item is classified as an inventory or prepackaged item such grocery or a service as shown at block 328, the dispatch schedule adjusts the dispatch time based on purchaser positional data 121 indicating when the purchaser is close to the dynamic delivery address as shown at block 330, and notify a vendor to collect the purchased item as shown block 332. The estimated time of arrival of purchaser (block 322) and/or the proximity of the purchaser to dynamic delivery address (block 330) are acquired from the purchaser module 102. The dispatch interface 126 may query the purchaser module 102 for purchaser positional data 121 to determine if the purchaser has arrived within a prescribed time window as shown at block 334 and initiate delivery as shown at block 336. If the purchaser has not arrived within a prescribed time window, the dispatch interface 126 may update the delivery data 123 to confirm that the purchaser has made a route change as shown at block 338 and transfer control to a dispatch module 106 at a different location based on the route change as shown in block 340, in which case process control returns to block 312 for re-determining the dispatch schedule. In this regard, when the dynamic delivery address deviates from the delivery route, the delivery interface may respond to the delivery route deviation by changing the delivery route to accommodate the dynamic delivery address deviation or transferring the dispatch schedule to a second vendor based on the delivery route deviation, proximity of a second vendor to the dynamic delivery address and/or estimated time of purchaser arrival. This concludes the coordinate dispatch function 204.

In reference now to FIG. 3B, the delivery of the purchased good is coordinated by the delivery module 108 which generates a delivery schedule including a delivery route based on the delivery data 123 including dynamic delivery address, the updated location and the estimated time for arrival. In some instances a delivery location may also be determined based on the delivery mode, the delivery schedule and issued to the delivery interface 132. An updated purchaser location may be acquired by the delivery module 108 from the purchaser module 102 and the proximity of the purchaser module 102 and the delivery module 108 to the dynamic delivery address may be determined as shown at block 342 of FIG. 3B. The delivery schedule including a delivery time or other notification to update a delivery status may be issued to the purchaser module 102 as shown at block 344 and to delivery module 108 as shown at block 346. This concludes the coordinate delivery function 206.

Arrival of the purchaser module 102 at the dynamic delivery address is confirmed using position data 121 and delivery data 123 as shown at block 348. Likewise, arrival of the delivery module 108 at the dynamic delivery address is confirmed using position data 131 and delivery data 123, delivery person identification and purchase order number as shown at block 350. Once arrival of both the purchaser module 102 and/or the delivery module 108 have arrived at the dynamic delivery address, one respective module 102 or 108 may issue a confirmation request or provide one or more control signals to provide an audible or visual indication from the vehicles 104, 110 which may be responded to by the other respective module 102 or 108 with a confirmation response.

Thus, confirmation data 125 indicating that the purchased item has been received may be issued from the purchaser module 102 as shown at block 352. Likewise, confirmation data 135 indicating that the purchased item has been delivered may be issued from the delivery module 108 as shown at block 354. Confirmation data 125, 135 may be exchanged between the purchaser module 102 and the delivery module 108 with NFC device 136, 140 as shown at blocks 356, 358 and acquired by the dispatch module 106 with the NFC device 138 or over the data network 112 for closing the delivery transaction.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for dispatching and delivering a purchased item to a dynamic delivery address, the method comprising:
acquiring a delivery mode including a dynamic delivery address for delivery of a purchased item from a mobile purchaser module;
estimating a time for delivery based on the delivery mode, the dynamic delivery address and an initial location of the mobile purchaser module;
determining a dispatch schedule based on the delivery mode, the initial location and the estimated time for delivery;
issuing the dispatch schedule for dispatching the purchased item;
acquiring an updated location from the mobile purchaser module;
determining a delivery schedule including a delivery route based on the dynamic delivery address, the updated location and the estimated time for delivery;
issuing the delivery schedule to a delivery interface; and
acquiring confirmation for delivery of the purchased item to the dynamic delivery address.

2. The method according to claim 1 wherein the delivery mode comprises at least one of an in-route pick-up point, a daily route, and an activity history.

3. The method according to claim 2 further comprising determining a delivery location based on the delivery mode and the delivery schedule, and issuing the delivery location to the delivery interface.

4. The method according to claim 1 further comprising determining the dispatch schedule based on a classification of the purchased item.

5. The method according to claim 4 wherein the classification of the purchased item comprises one of a prepared item and a made-to-order item.

6. The method according to claim 4 wherein issuing the dispatch schedule comprises issuing a notification to prepare the purchased item based on the characteristic of the purchased item.

7. The method according to claim 1 further comprising updating the delivery schedule based on at least one of an updated location of the mobile purchaser module and a current location acquired from the delivery module.

8. The method according to claim 1 further comprising identifying a delivery route deviations when the dynamic delivery address deviates from the delivery route, and responding to the delivery route deviation, wherein the response comprises one of changing the delivery route to accommodate the dynamic delivery address deviation and issuing a revised dispatch schedule.

9. The method according to claim 1 further comprising comparing the updated location with the delivery location and issuing a notification to at least one of the mobile purchaser interface and the delivery interface.

10. The method according to claim 1 wherein acquiring confirmation comprises at least one of acquiring a purchase item received acknowledgement from the mobile interface and acquiring a purchase item delivered from the delivery interface.

11. The method according to claim 10 wherein the confirmation is acquired by near field communication.

12. The method according to claim 1 further comprising monitoring a deviation from the dynamic delivery address, and responding to said deviation by at least one of the following actions: changing the dispatch schedule, transferring the dispatch schedule, and changing the delivery route to accommodate the dynamic delivery address deviation.

13. The method according to claim 1 further comprising tracking at least one of a location relative to the dynamic delivery address and an estimated arrival time at the dynamic delivery address, and issuing a notification to at least one of the mobile purchaser interface and the delivery interface to update a delivery status.

14. The method according to claim 13 wherein the delivery status comprises at least one of on-the-way, time changed, address changed, newly-dispatched, canceled or completed.

15. A method for dispatching a purchased item for delivery to a dynamic delivery address, the method comprising:
acquiring a delivery mode including a dynamic delivery address for delivery of a purchased item from an mobile purchaser interface in a vehicle;
estimating a time of arrival based on the delivery mode, the dynamic delivery address and an initial location of the vehicle;
determining a dispatch schedule based on the delivery mode, the initial location and the estimated time for arrival;
issuing the dispatch schedule to a vendor for dispatching the purchased item;
acquiring an updated location for the vehicle and estimating an updated time of arrival;
determining a delivery schedule including a delivery route based on the dynamic delivery address, the updated location and the updated estimated time of arrival; and
issuing the delivery schedule to a delivery interface.

16. A dispatch and delivery system to facilitate delivery of a purchased item to a dynamic delivery address comprising:
a mobile purchaser module having a first telematics device configured to acquire purchaser position data for locating the purchaser module, and a purchaser interface configured to issue delivery data to and acquire delivery data from the dispatch and delivery system, the delivery data including a delivery mode, a dynamic delivery address and a purchaser confirmation;
a dispatch module having a dispatch interface configured to issue delivery data to and acquire delivery data from the dispatch and delivery system, the dispatch module further configured to estimate a time for delivery based on the delivery mode, the dynamic delivery address and location data for the purchaser interface, and determine a dispatch schedule based on the delivery mode, the initial location and the estimated time for delivery, wherein the delivery data further includes the estimate time for delivery and the dispatch schedule; and
a delivery module configured to be deployed remote from the purchaser module, the delivery module having a second telematics device configured to acquire delivery position data for locating the delivery module, and a delivery interface for issuing delivery data to and acquiring delivery data from the dispatch and delivery system, the delivery module further configured to acquire an updated location from the mobile purchaser interface, determine a delivery schedule including a delivery route based on the dynamic delivery address, an updated location and the estimated time for delivery, issue a delivery schedule, and confirm delivery of the purchased item to the dynamic delivery address, wherein the delivery data further includes the delivery schedule, the delivery route and a delivery confirmation.

17. The dispatch and delivery system according to claim 16 wherein at least one of the purchaser module and the delivery module further comprises a near field communication device for issuing or acquiring at least one of the purchaser confirmation and the delivery confirmation.

18. The dispatch and delivery system according to claim 16 wherein at least one of the purchaser module and the delivery module further comprises a display device configured to display delivery data.

19. The dispatch and delivery system according to claim 16 wherein at least one of the purchaser interface and the delivery interface further comprises an input device configured to receive delivery data.

20. The dispatch and delivery system according to claim 16 wherein at least one of the purchaser module and the delivery module further comprises a handheld computing device having a microprocessor and an application program executed thereon.
